(19) United States
(12) Patent Application Publication
(10) Pub. No.: US 2013/0297651 A1
(43) Pub. Date: Nov. 7, 2013

(54) APPLICATION SEARCH SYSTEM

(71) Applicant: Dae Young Kim, Seoul (KR)

(72) Inventor: Dae Young Kim, Seoul (KR)

(21) Appl. No.: 13/637,594

(22) PCT Filed: Feb. 22, 2011
(86) PCT No.: PCT/KR2011/001139

§ 371 Date: Jul. 5, 2013

(30) Foreign Application Priority Data
Mar. 25, 2010 (KR) 10-2010-0026916

(51) Int. Cl. G06F 17/30

(52) U.S. Cl. CPC G06F 17/30545
USPC 707/770

(57) ABSTRACT

An application search method is executed in an application search system including a terminal for executing an application and a registration server, the terminal transmits an identifier for the application and the web address of retrieved web data to the registration server whenever the application searches for the web data, and the registration server associates the identifier for the application with the web address of the web data.

### CROSS-REFERENCE TO RELATED APPLICATIONS

This application is the United States National Phase under 35 U.S.C. §371 of PCT International Patent Application No. PCT/KR2011/001139, which designated the United States of America, having an International Filing date of Feb. 22, 2011, and claiming priority to Korean Application No. 10-2010-0026916, filed Mar. 25, 2010.

### BACKGROUND OF THE INVENTION

1. Technical Field

The disclosed technology relates to an application search system and, more particularly, to a search system for searching an application capable of providing web data and information on the web data.

2. Background Art

A terminal may access a server, download an application from the server, and execute the downloaded application. An application may access a server over an IP network, search the server for data, and show the data at it is or modified data to a user. For example, an application may search a server for web data (e.g., web pages and images, data files, Word documents, Excel documents, or PDF documents within a web) and display all or some of the web data. Alternatively, the application may produce new contents based on the retrieved web data and display the new contents.

Meanwhile, a web search server (e.g., a portal server) may search for web data within a web through a web search engine, but cannot search for an application for searching for the corresponding web data, which makes it difficult for a user to know that specific information is used in what application. For example, if a specific word (e.g., a subway) is retrieved by a web search server, a terminal may obtain web data related to the specific word, but it is difficult for a user to know an application that is associated with the corresponding web data.

### SUMMARY OF THE INVENTION

In embodiments, an application search method is executed in an application search system including a terminal for executing an application and a registration server. In the application search method, the terminal transmits an identifier for the application and the web address of web data, used by the application, to the registration server, and the registration server associates the identifier for the application with the web address of the web data.

In embodiments, an application search system includes a terminal for transmitting an identifier for an application and the web address of web data used by the application to a registration server and the registration server for associating the identifier for the application with the web address of the web data.

In embodiments, an application search method is executed in an application search system including a web server for storing one or more web data and a registration server, wherein the one or more web data are distinguished from one another by web addresses, at least first part of the one or more web data includes an application identifier indicative of information on an application for searching for the one or more web data in a metadata form, and the at least first part is executed by a terminal. The registration server searches the web server for at least second part of the one or more web data and associates the application identifier, included in the retrieved web data in the metadata form, with the web address of the retrieved web data.

In embodiments, an application search system includes a web server for storing one or more web data and a registration server, wherein the one or more web data are distinguished from one another by web addresses, at least first part of the one or more web data includes an application identifier indicative of information on an application for searching for the one or more web data in a metadata form, and the at least first part is executed by a terminal. The registration server searches the web server for at least second part of the one or more web data and associates the application identifier, included in the retrieved web data in the metadata form, with the web address of the retrieved web data.

In embodiments, an application search method is executed in an application search system including a terminal for executing an application, a proxy server, and a registration server. The terminal transmits an identifier for the application and a web address of web data, used by the application, to the proxy server, the proxy server transmits web data, retrieved based on the web address, to the terminal, the proxy server transmits the identifier for the application and the web address of the web data used by the application to the registration server, and the registration server associates the identifier for the application with the web address of the web data.

In embodiments, an application search system includes a terminal for transmitting an identifier for an application and the web address of web data, used by the application, to a proxy server, the proxy server for transmitting web data retrieved based on the web address to the terminal and transmitting the identifier for the application and the web address of the web data, used by the application, to a registration server, and the registration server for associating the identifier for the application with the web address of the web data.

In embodiments, a registration server includes a communication unit connected to a terminal for executing an application and transmitting an identifier for the application and the web address of retrieved web data to a registration server whenever the application searches for the web data and configured to receive the identifier for the application and the web address of the retrieved web data and a database configured to store a link between the identifier for the application and the web address of the retrieved web data.

In embodiments, a registration server includes a collecting unit connected to a web server for storing one or more web data—the one or more web data are distinguished from one another by web addresses, at least first part of the one or more web data includes an identifier for an application indicative of information on the application for searching for the web data in the form of metadata, and the application is executed by a terminal—and configured to search the web server for at least second part of the one or more web data and a database configured to store a link between the identifier for the application, included in the retrieved web data in the form of the metadata, and the web address of the retrieved web data.

In embodiments, a terminal is connected to a registration server and is configured to execute an application and transmit an identifier for the application and the web address of web data, used by the application, to the registration server, and the registration server stores a link between the identifier for the application and the web data retrieved by the application.

### BRIEF DESCRIPTION OF THE DRAWINGS

FIG. 1 is a diagram illustrating an application search system in accordance with an embodiment of the disclosed technology.

FIG. 2 is a block diagram illustrating a terminal of FIG. 1.

FIG. 3 is a block diagram illustrating a registration server of FIG. 1.

FIG. 4 is a flowchart illustrating an application search method that is performed in the application search system of FIG. 1.

FIG. 5 is a diagram illustrating an application search system in accordance with another embodiment of the disclosed technology.

FIG. 6 is a block diagram illustrating a registration server of FIG. 5.

FIG. 7 is a flowchart illustrating a first example of an application search method that is executed in the application search system of FIG. 5.

FIG. 8 is a flowchart illustrating a second example of an application search method that is executed in the application search system of FIG. 5.

FIG. 9 is a diagram illustrating an application search system in accordance with yet another embodiment of the disclosed technology.

FIG. 10 is a flowchart illustrating an application search method that is performed in the application search system of FIG. 9.

FIG. 11 is a diagram illustrating a shortcut.

### DETAILED DESCRIPTION OF THE INVENTION

A description of the disclosed technology is only embodiments for structural and/or functional descriptions. The scope of the disclosed technology should not be construed as being limited to the following embodiments. That is, the embodiments may be modified in various forms, and the scope of the disclosed technology should be understood as including equivalents which may realize the technical spirit.

Meanwhile, the meanings of terms described in this application should be understood as follows.

Terms, such as the “first” and the “second”, are used to distinguish one element from the other element, and the scope of the disclosed technology should not be restricted by the terms. For example, a first element may be named a second element. Likewise, a second element may be named a first element.

A term “and/or” should be understood to include all combinations which may be presented from one or more related items. For example, “a first item, a second item and/or a third item” means “at least one of the first item, the second item, and the third item” and means a combination of all items which may be presented from two or more of not only the first, second, or third item but also the first, the second, and the third items.

When it is said that one element is described as being “connected” to the other element, the one element may be directly connected to the other element, but it should be understood that a third element may be interposed between the two elements. In contrast, when it is said that one element is described as being “directly connected” to the other element, it should be understood that a third element is not interposed between the two elements. Meanwhile, the same principle applies to other expressions, such as “between ˜” and “just between ˜” or “adjacent to ˜” and “adjacent just to ˜”, which describe a relation between elements.

An expression of the singular number should be understood to include plural expressions, unless clearly expressed otherwise in the context. Terms, such as “include” or “have”, should be understood to indicate the existence of a set characteristic, number, step, operation, element, part, or a combination of them and not to exclude the existence of one or more other characteristics, numbers, steps, operations, elements, parts, or a combination of them or a possibility of the addition of them.

In each of steps, symbols (e.g., a, b, and c) are used for convenience of description, and the symbols do not describe order of the steps. The steps may be performed in order different from order described in the context unless specific order is clearly described in the context. That is, the steps may be performed according to described order, may be performed substantially at the same time, or may be performed in reverse order.

All terms used herein, unless otherwise defined, have the same meanings which are commonly understood by those having ordinary skill in the art. In general, terms, such as ones defined in dictionaries, should be interpreted as having the same meanings as terms in the context of relevant technology, and should not be interpreted as having ideal or excessively formal meanings unless clearly defined in this application.

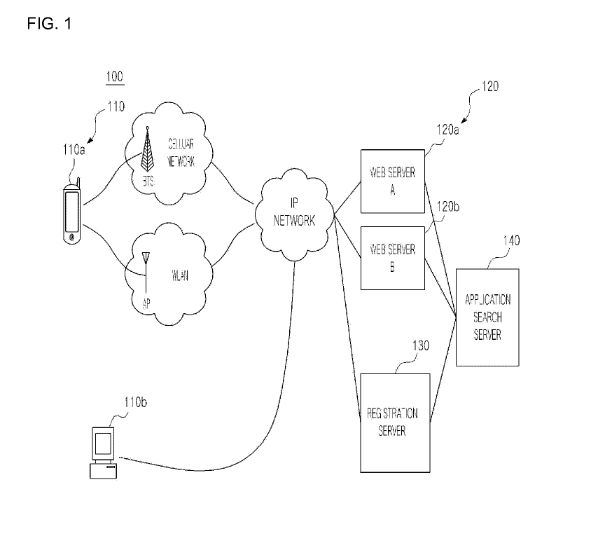

FIG. 1 is a diagram illustrating an application search system in accordance with an embodiment of the disclosed technology.

Referring to FIG. 1, the application search system 100 includes a terminal 110, a web server 120, a registration server 130, and an application search server 140. The terminal 110 may correspond to a mobile terminal 110a, a Mobile Internet Device (MID), such as iPad, or a wired terminal 110b. The mobile terminal 110a may correspond to a complex type wireless communication device in which advantages of a mobile phone and a Personal Digital Assistant (PDA) are combined. In the mobile terminal 110a, common telephone service may be used over a cellular network, and data service may be used over a Wireless Local Area Network (WLAN), such as WiFi or Bluetooth, or a wireless packet network, such as Code Division Multiple Access (CDMA) or Wideband Code Division Multiple Access (WCDMA). The mobile terminal 110a may be connected to an Internet Protocol (IP) network over a cellular network, a WLAN, or a wireless packet network and may be connected to the web server 120, the registration server 130, and the application search server 140 over the IP network.

The wired terminal 110b may correspond to a device capable of performing communication in a wired manner, such as a Personal Computer (PC) or an IP telephone. The wired terminal 110b may be connected to an IP network through a Digital Subscriber Line (DSL) or over a cable network and may be connected to the web server 120, the registration server 130, and the application search server 140 over the IP network.

The terminal 110 may include at least one application and execute the application under the control of a user. Whenever an application searches for web data (e.g., web pages or images or files within a web), the terminal 110 transmits an identifier for the application and the web address of the retrieved web data to the registration server 130. In an embodiment, whenever the state of an application is changed, whenever the application searches for new web data and/or periodically, the terminal 110 may transmit an identifier for the application and the web address of the retrieved web data to the registration server 130. In an embodiment, a corresponding function may be executed by an application, and a developer who produces the application may embody the corresponding function in the application. In another embodiment, a corresponding function may be executed by the terminal 110. In the following description, the meaning that the terminal 110 performs transmission to the registration server 130 includes that the terminal 110 performs transmission and that an application included in the terminal 110 performs transmission.

In an embodiment, the terminal 110 may further transmit a shortcut that may be used in an application to the registration server 130. In an embodiment, the shortcut may be generated by a corresponding application. If a shortcut is received, a corresponding application searches for web data based on the web address of the web data by immediately executing a state corresponding to the shortcut (i.e., the state of the corresponding application when the shortcut is transmitted to the registration server 130) so that the retrieved web data can be immediately used. The web server 120 stores one or more web data, and the web data are distinguished from one another by web addresses (e.g., web URLs). The registration server 130 associates an identifier for an application, received from the terminal 110, with the web address of retrieved web data and stores a link therebetween. In an embodiment, the registration server 130 may associate a shortcut, received from the terminal 110, with an identifier for an application and the web address of retrieved web data and store a link therebetween.

In an embodiment, if an application uses only part of retrieved web data without using all the retrieved web data, the terminal 110 may transmit information on the web data used by the application, together with an identifier for the application, to the registration server 130. For example, if an application accesses the web server 120, searches the web server 120 for a web page, and uses only part of information within the retrieved web page, the terminal 110 may transmit corresponding information to the registration server 130. For example, if an application uses a list of France wines from among pieces of information included in a web page, the application may transmit a phrase “List of France wines” or the file name of corresponding data, together with an identifier for the application, to the registration server 130.

In an embodiment, if an application uses not only web data but also possessed data, the terminal 110 may transmit the address of the web data, information on data used by the application, from among the possessed data, and an identifier for the application to the registration server 130. For example, if an application displays information on wines using a web page retrieved through a web address (e.g., www.wine.com/francewine.html) and a list of Chile wines possessed by the application, the terminal 110 may transmit an identifier for the application, a shortcut corresponding to a state in which the information on wines is displayed, the URL of web data, and a phrase “List of Chile wines” or a file name to the registration server 130.

The application search server 140 searches for web data, corresponding to a search word, and an application for searching for the corresponding web data based on the search word that has been received from a search client and transmits the results of the search to the search client. In an embodiment, the results of the search may include not only information on the web data but also an identifier for the application for searching for the corresponding web data. In an embodiment, the results of the search may include information on the web data and an identifier and shortcut for the application. In an embodiment, the results of the search may include an identifier and shortcut for the application.

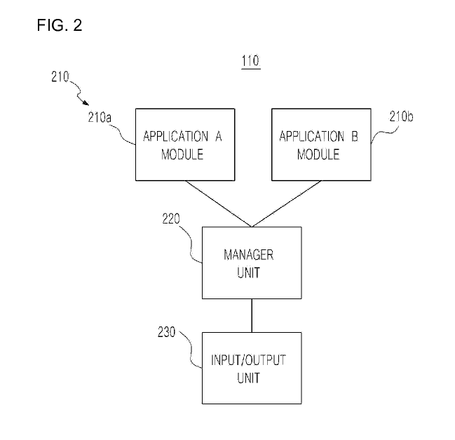

FIG. 2 is a block diagram illustrating the terminal 110 of FIG. 1.

Referring to FIG. 2, the terminal 110 includes an application module 210, a manager unit 220, and an input/output unit 230. The application module 210 may access the web server 120 and search the web server 120 for web data. In an embodiment, whenever the state of an application is changed, whenever the application searches for new web data and/or periodically, the application module 210 may transmit an identifier for the application and the web address of the retrieved web data to the registration server 130.

The manager unit 220 controls the elements of the terminal 110, and the input/output unit 230 performs an input/output operation on devices outside the terminal 110. For example, the input/output unit 230 may access external devices over a cellular network, a WLAN, or wired/wireless packet network and perform input/output operation.

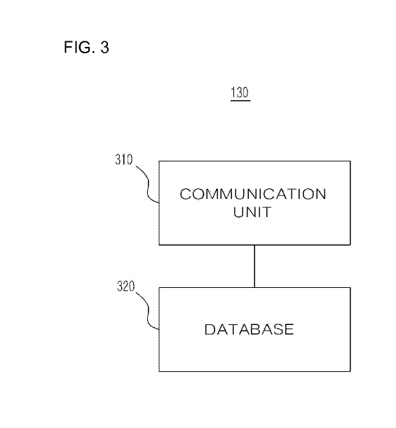

FIG. 3 is a block diagram illustrating the registration server 130 of FIG. 1.

Referring to FIG. 3, the registration server 130 includes a communication unit 310 and a database 320. The communication unit 310 receives an identifier for an application received from the terminal 110 and the web address of web data retrieved by the terminal 110. In an embodiment, the communication unit 310 may further receive a shortcut.

The database 320 stores a link between an identifier for an application and the web address of web data. In an embodiment, the database 320 may store a link between an identifier for an application, the web address of web data, and a shortcut.

In an embodiment, the database 320 may store the web address of web data and a shortcut which are associated with each of identifiers for respective applications. In another embodiment, the database 320 may store an identifier and shortcut for an application for searching for web data for each of the web addresses of the web data.

In an embodiment, the registration server 130 may receive a link between an identifier for an application and the web address of web data from the computer of a manager or application provider, and the database 320 may store a link between an identifier for an application and the web address of web data that is associated with the corresponding identifier. For example, if an application uses information on 1000 restaurants, an application provider may access the registration server 130 through a computer and store a link between the web address of a web page, including information on each of the 1000 restaurants, and an identifier for the application in the registration server 130.

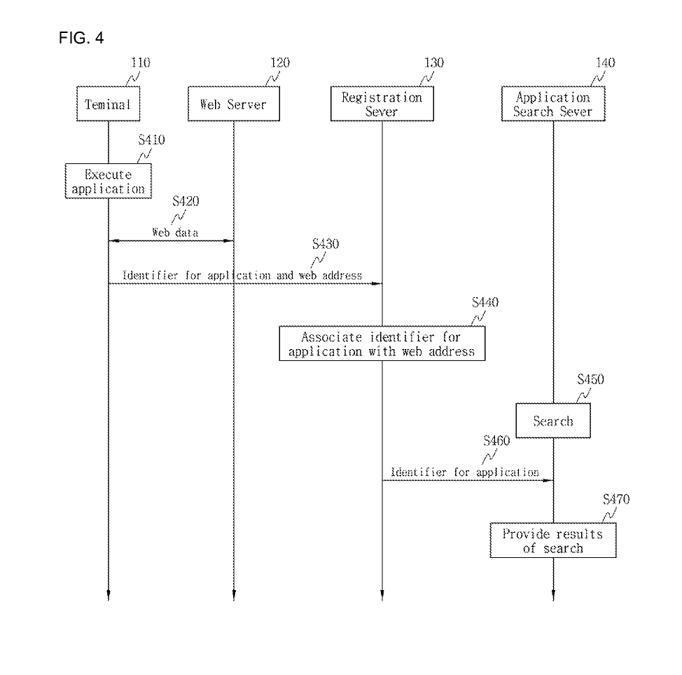

FIG. 4 is a flowchart illustrating an application search method that is performed in the application search system of FIG. 1.

The terminal 110 executes an application under the control of a user at step S410. The application accesses the web server 120 through a web address and searches for web data at step S420. The terminal 110 transmits an identifier for the application and the web address of the retrieved web data to the registration server 130 at step S430. In an embodiment, whenever the change of the application is changed, whenever the application searches for new web data and/or periodically, the terminal 110 may transmit the identifier for the application and the web address of the retrieved web data to the registration server 130.

In an embodiment, the terminal 110 may further transmit a shortcut to the registration server 130. In an embodiment, the identifier for the application may correspond to the name of the application or a code assigned when the application is registered. The code may include information on the application. For example, a user may know information on the type of application, the version number of the application, and an Operating System (OS) and/or a HW model in which the application operates based on the code. For example, in relation to the same “WINGBUS FAMOUS RESTAURANT” application, the “WINGBUS FAMOUS RESTAURANT” application that may operate in a terminal on which Android is mounted and the “WINGBUS FAMOUS RESTAURANT” application that may operate in iPhone may have different code numbers.

The registration server 130 associates the identifier for the application with the web address of the web data retrieved by the application at step S440. In an embodiment, if a shortcut is further received from the terminal 110, the registration server 130 may associate the identifier for the application with the web address of the web data, retrieved by the application, and the shortcut. In an embodiment, if there is a link, the registration server 130 may update a count based on the number of times that a corresponding application has accessed corresponding web data.

The application search server 140 searches for web data, corresponding to a search word, and an application for searching for the web data based on the search word received from a search client at step S450. The application search server 140 may perform web crawling on the web data through a web crawler and index the web data through search engines in advance in order to reduce the time taken to search for the web data.

The application search server 140 searches for web data corresponding to the search word based on the search word and may access the registration server 130 and obtain the identifier for the application for searching for the corresponding web data at step S460. The application search server 140 may transmit the identifier for the application for searching for the web data, together with information on the web data corresponding to the search word, to the search client at step S470. In an embodiment, the application search server 140 may obtain the shortcut, together with the identifier for the application for searching for the web data, from the registration server 130 and transmit the identifier and shortcut for the application for searching for the web data, together with information on the web data corresponding to the search word, to the search client.

In an embodiment, the application search server 140 may transmit the information on the web data and the identifier for the application to the search client depending on the type of OS in which the application may be executed. In an embodiment, the application search server 140 may further transmit the shortcut. For example, the application search server 140 may transmit the information on the web data, corresponding to the search word, and the identifier for the application which searches for the web data and in which Android is executed to the search client. In an embodiment, the application search server 140 may determine the type of OS under the control of a user and search for an application.

In an embodiment, if a search client corresponds to a terminal and a shortcut is received, the terminal may enable a corresponding application to immediately use corresponding web data through the shortcut. For example, a shortcut may include a command that enables an application to search for web data and immediately uses the retrieved web data. If a shortcut is selected under the control of a user, an application may search for web data and use the retrieved web data immediately.

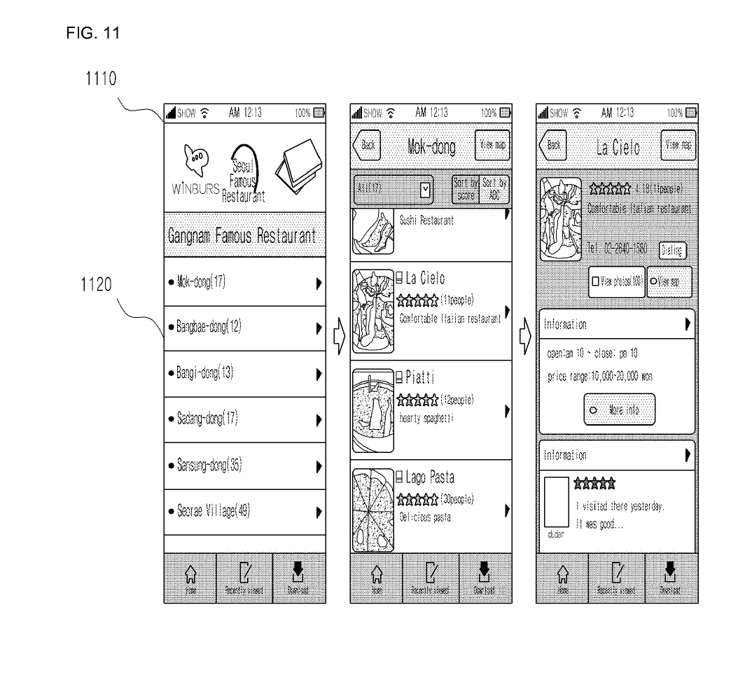

FIG. 11 is a diagram illustrating a shortcut.

In FIG. 11, it is assumed that famous restaurants are searched for in a famous restaurant application 1110 through a famous restaurant list 1120. In FIG. 11, the famous restaurant application 1110 may select a famous restaurant under the control of a user, access the home page server or famous restaurant evaluation web data server of the famous restaurant, and search for home page or famous restaurant evaluation web data. For example, in FIG. 11, if “La Cielo” is selected, the famous restaurant application 1110 may access a “La Cielo” home page server or famous restaurant evaluation web data server, search for home page or famous restaurant evaluation web data, and use images and/or text for “La Cielo” that are included in the retrieved home page or famous restaurant evaluation web data.

The famous restaurant application 1110 may select an area in the famous restaurant list 1120 under the control of a user, select a specific famous restaurant from famous restaurants included in the selected area, and search for information on the selected specific famous restaurant. In this case, a shortcut may include a command for selecting the specific famous restaurant in the famous restaurant application 1110. For example, a shortcut that enables the famous restaurant application 1110 to use home page or famous restaurant evaluation web data for “La Cielo” immediately may include an instruction that instructs a user to go to “GANGNAM IN A FIRST PAGE, MOK-DONG IN A SECOND PAGE, AND THEN LA CIELO IN A THIRD PAGE”.

For another example, if the famous restaurant application 1110 may receive “La Cielo” through a search window and search for famous restaurants, a shortcut may include an instruction that indicates a user to “INPUT AND SEARCH FOR LA CIELO IN THE SEARCH WINDOW OF A FIRST PAGE”.

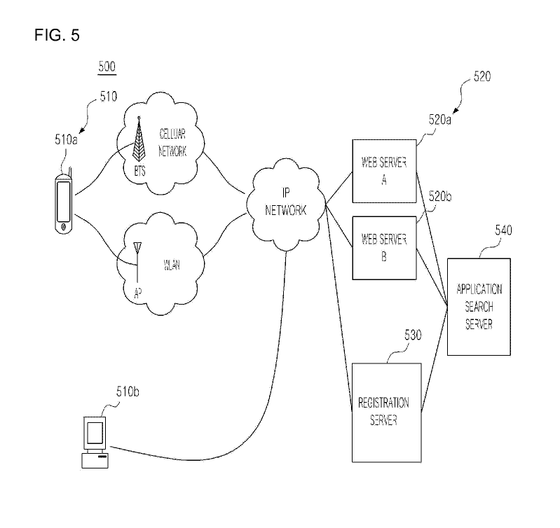

FIG. 5 is a diagram illustrating an application search system in accordance with another embodiment of the disclosed technology.

Referring to FIG. 5, the application search system 500 includes a terminal 510, a web server 520, a registration server 530, and an application search server 540. The terminal 510 may correspond to a mobile terminal 510a, an MID, such as iPad, or a wired terminal 510b. The mobile terminal 510a may correspond to a complex type wireless communication device in which advantages of a mobile phone and a PDA are combined. In the mobile terminal 510a, common telephone service may be used over a cellular network, and data service may be used over a WLAN, such as WiFi or Bluetooth, or a wireless packet network, such as CDMA or WCDMA. The mobile terminal 510a may be connected to an IP network over a cellular network, a WLAN, or a wireless packet network and may be connected to the web server 520, the registration server 530, and the application search server 140 over the IP network.

The wired terminal 510b may correspond to a device capable of performing communication in a wired manner, such as a Personal Computer (PC) or an IP telephone. The wired terminal 510b may be connected to an IP network through a Digital Subscriber Line (DSL) or over a cable network and may be connected to the web server 520, the registration server 530, and the application search server 140 over the IP network.

The terminal 510 may include at least one application and execute the application under the control of a user. An application may access the web server 520 and search for web data. The web server 520 stores one or more web data, and the web data are distinguished from one another by web addresses. At least first part of the one or more web data includes an application identifier, indicating information on the application for searching for the web data, in the form of metadata. In an embodiment, the at least first part may further include a shortcut that enables the application to use the web data immediately using the web address of the web data in the form of metadata.

The registration server 530 searches the web server 520 for at least part of the one or more web data, associates an application identifier, included in the retrieved web data in the form of metadata, with the web address of the web data, and stores a link between the application identifier and the web address of the web data. In an embodiment, if a shortcut is further included in the metadata of the retrieved web data, the registration server 530 may associate the shortcut with the identifier for the application and the web address of the retrieved web data and store a link therebetween.

The application search server 540 searches for web data corresponding to a search word and an application for searching for the web data based on the search word received from a search client and transmits the results of the search to the search client. In an embodiment, the results of the search may include not only information on the web data but also an identifier for the application for searching for the web data. In another embodiment, the results of the search may include information on the web data and an identifier and shortcut for a client.

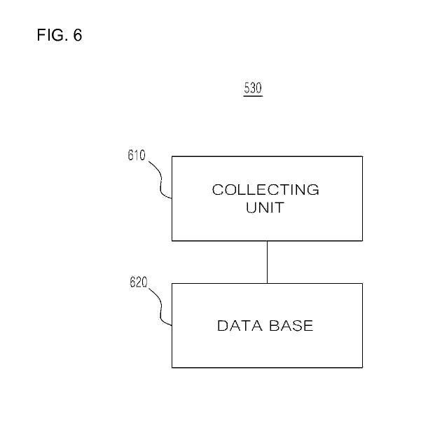

FIG. 6 is a block diagram illustrating the registration server 530 of FIG. 5.

Referring to FIG. 6, the registration server 530 includes a collecting unit 610 and a database 620. The collecting unit 610 searches the web server 520 for at least part of one or more web data. In an embodiment, the collecting unit 610 may search for the web data through a web crawler.

The database 620 stores a link between an application identifier, included in retrieved web data in the form of metadata, and the web address of the retrieved web data. In an embodiment, the database 620 may store a link between an identifier for an application, the web address of web data, and a shortcut.

In an embodiment, the database 620 may store the web address of web data and a shortcut which are associated to each of application identifiers. In another embodiment, the database 620 may store an application identifier and shortcut for an application for searching for web data in relation to each of the web addresses of the web data.

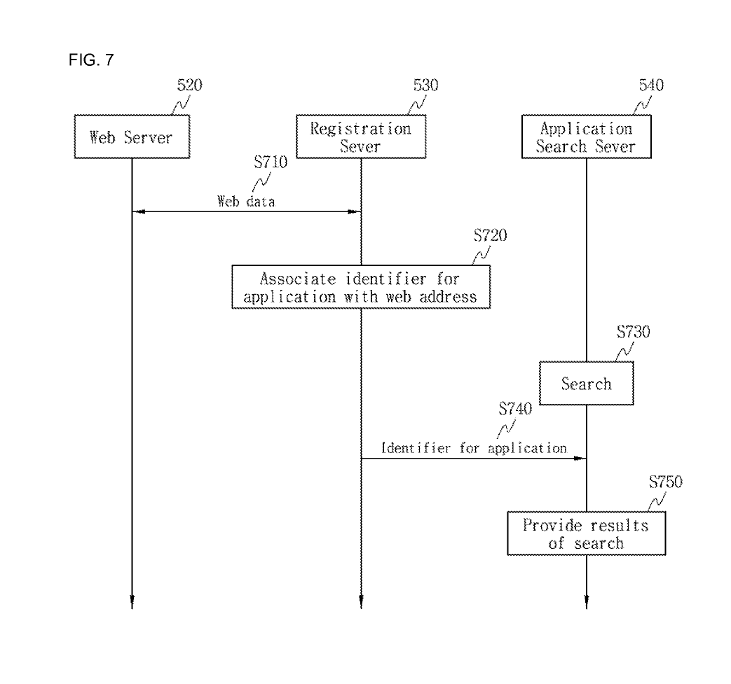

FIG. 7 is a flowchart illustrating a first example of an application search method that is executed in the application search system of FIG. 5.

The web server 520 stores one or more web data, and the web data may be distinguished from one another by web addresses. At least first part of the one or more web data stored in the web server 520 includes an application identifier, indicating information on an application for searching for the web data, in the form of metadata. In an embodiment, the at least first part may further include a shortcut in the form of metadata. In an embodiment, the application identifier and the shortcut may be stored in advance by the producer of the web data.

The registration server 530 searches the web server 520 for at least part of the one or more web data at step S710 and associates an application identifier, included in the retrieved web data in the form of metadata, with the web address of the web data at step S720. In an embodiment, if a shortcut is further included in the metadata of the retrieved web data, the registration server 530 may associate the application identifier with the web address of the web data and the shortcut.

The application search server 540 searches for web data, corresponding to a search word, and an application for searching for the web data based on the search word received from a search client at step S730. The application search server 540 may perform web crawling on the web data through a web crawler and index the web data through search engines in advance in order to reduce the time taken to search for the web data.

The application search server 540 may search for the web data corresponding to the search word based on the search word, access the registration server 530, and obtain an identifier for the application for searching for the web data at step S740. The application search server 540 may transmit the identifier for the application for searching for the web data, together with information on the web data corresponding to the search word, to the search client at step S750. In an embodiment, the application search server 540 may obtain a shortcut, together with the identifier for the application for searching for the web data, from the registration server 530 and transmit the identifier and shortcut for the application for searching for the web data, together with the information on the web data corresponding to the search word, to the search client.

In an embodiment, the application search server 540 may transmit the information on the web data and the identifier for the application to the search client depending on an OS in which the application may be executed. In an embodiment, the application search server 540 may further transmit the shortcut. In an embodiment, the application search server 540 may determine the type of OS in advance under the control of a user and search for an application.

In an embodiment, if a search client corresponds to a terminal and a shortcut is received, the terminal may enable a corresponding application to use corresponding web data immediately through the shortcut.

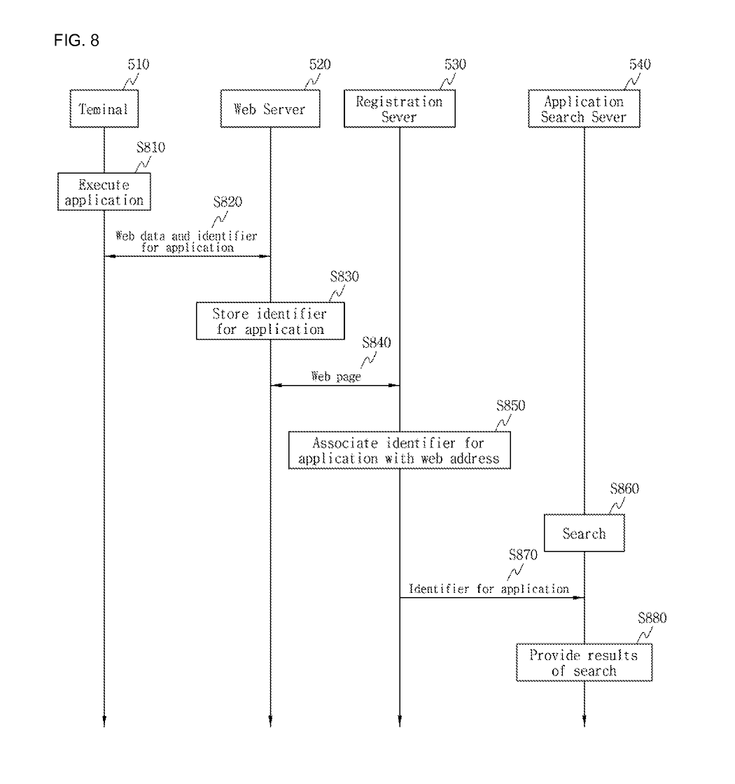

FIG. 8 is a flowchart illustrating a second example of an application search method that is executed in the application search system of FIG. 5.

The terminal 510 executes an application under the control of a user at step S810. The application accesses the web server 520 through a web address and searches for web data. Whenever the application searches for web data, the terminal 510 transmits an identifier for the application for searching for the web data to the web server 520 at step S820. In an embodiment, the terminal 110 may further transmit a shortcut to the web server 520. In an embodiment, the identifier for the application may correspond to a code assigned when the name of the application or the application is registered. In an embodiment, the shortcut may be generated by the application.

The web server 520 stores the application identifier, received from the terminal 510, in the web data in the form of metadata at step S830. In an embodiment, if a shortcut is further received, the web server 520 may store the shortcut in corresponding web data in the form of metadata. In order for the web server 520 to store the application identifier and the shortcut in the web data in the form of metadata, the producer of the web data or the manager of the web data has to assign authority to modify the web data to the web server 520.

The registration server 530 searches the web server 520 for at least part of one or more web data in at step S840 and associates the application identifier, stored in the retrieved web data, in the form of metadata with the web address of the web data at step S850. In an embodiment, if a shortcut is further included in the metadata of the retrieved web data, the registration server 530 may associate the application identifier with the web address of the web data and the shortcut. The steps S860 to S880 are the same as the steps S730 to S750 of FIG. 7, and thus a description thereof is omitted for simplicity.

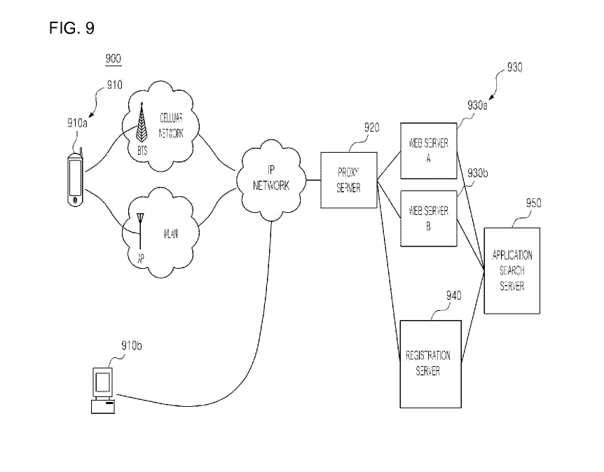

FIG. 9 is a diagram illustrating an application search system in accordance with yet another embodiment of the disclosed technology.

Referring to FIG. 9, the application search system 900 includes a terminal 910, a proxy server 920, a web server 930, a registration server 940, and an application search server 950. A description of the same contents as those of FIG. 1 is omitted, and a difference between the application search system of FIG. 1 and the application search system of FIG. 9 is chiefly described.

The terminal 910 may search the proxy server 920 for web data. When the web data are retrieved, the terminal 910 may transmit an identifier for an application and the web address of the web data retrieved by the application to the proxy server 920. In an embodiment, the terminal 910 may further transmit a shortcut to the proxy server 920.

The proxy server 920 relays the web data between the terminal 910 and the web server 930 based on the web address received from the terminal 910 and stores the application identifier and the web address of the web data which have been received from the terminal 910. If a shortcut is further received, the proxy server 920 may store the application identifier, the shortcut, and the web address of the web data retrieved by the application.

The proxy server 920 transmits the application identifier and the web address of the web data, retrieved by the application, to the registration server 940. In an embodiment, the proxy server 920 may transmit the application identifier and the web address of the web data, retrieved by the application, to the registration server 940 periodically. In an embodiment, the proxy server 920 may further transmit the shortcut to the registration server 940.

The registration server 940 associates the received application identifier with the received web address of the web data and stores a link therebetween. In an embodiment, the registration server 940 may associate the shortcut, received from the terminal 910, with the identifier for the application and the web address of the retrieved web data and store a link therebetween.

The disclosed application search system can reduce costs due to the transmission of data because it can reduce the amount of data transmitted by a terminal, and the disclosed application search system can be embodied without changing the existing web server.

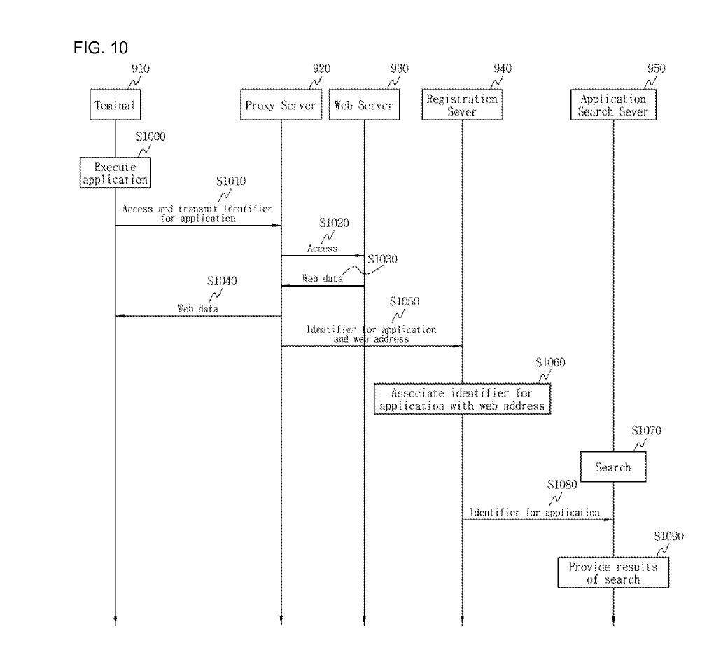

FIG. 10 is a flowchart illustrating an application search method that is performed in the application search system of FIG. 9. A description of the same contents as those of FIG. 4 is omitted, and a difference between the application search method of FIG. 4 and the application search system of FIG. 10 is chiefly described.

The terminal 910 executes an application under the control of a user at step S1000. The application transmits the web address of web data to be retrieved and an identifier for the application at step S1010, and the proxy server 920 accesses the web server 930 based on the received web address at step S1020. The proxy server 920 searches the web server 930 for the web data at step S1030 and transmits the retrieved web data to the terminal 910. In an embodiment, the application may further transmit a shortcut.

The proxy server 920 transmits an identifier for the application and the web address of the web data, retrieved by the application, to the registration server 930 at step S1050. In an embodiment, the proxy server 920 may transmit the identifier for the application and the web address of the web data, retrieved by the application, to the registration server 940 periodically. In an embodiment, the proxy server 920 may further transmit the shortcut to the registration server 130.

The registration server 940 associates the identifier for the application with the web address of the web data retrieved by the application at step S1060. In an embodiment, if the shortcut is further received from the terminal 910, the registration server 130 may associate the identifier for the application with the shortcut and the web address of the web data retrieved by the application. In an embodiment, if there is a link, the registration server 940 may update a count based on the number of times that the application has accessed the corresponding web data.

The disclosed technology may have the following advantages. However, it is to be noted that a specific embodiment should not construed as including all the following advantages or only the following advantages, and thus the scope of the disclosed technology should not be constructed as being limited thereto.

An application search system in accordance with an embodiment can search for an application desired by a user conveniently. The application search system may search for an application capable of providing information retrieved by a user without being limited to a search word provided by an application provider. Accordingly, a user can search for an application through which desired information can be obtained conveniently.

An application search system in accordance with an embodiment can search for web data and an application through which information on the web data can be provided at the same time. Furthermore, the application search system can provide connection information on which information on corresponding web data can be immediately checked in an application.

An application search system in accordance with an embodiment can demand payment depending on the position where an application is provided in the results of search. Accordingly, an application provider may advertise its own application by paying a predetermined cost to the application search system, and the application search system may profit through search service.

Although the some embodiments of the present invention have been described above, a person having ordinary skill in the art will appreciate that the present invention may be modified and changed in various ways without departing from the spirit and scope of the present invention.

What is claimed is:

1. An application search method executed in an application search system comprising a terminal for executing an application, a registration server, and an application search server, the application search method comprising:
the terminal transmitting an identifier for the application and a web address of web data, used by the application, to the registration server;
the registration server associating the identifier for the application with the web address of the web data; and
the application search server transmitting both information on the web data and the identifier for the application for searching for the web data to a search client when the web data is retrieved.

2. The application search method of claim 1, wherein the search client comprises the terminal.

3. The application search method of claim 1, wherein the application search server transmitting both information on the web data and the identifier for the application for searching for the web data to a search client when the web data is retrieved comprises the application search server accessing the registration server and obtaining the identifier for the application for searching for the web data.

4. The application search method of claim 1, wherein:
the terminal transmitting an identifier for the application and a web address of web data, used by the application, to the registration server comprises transmitting a shortcut usable in at least one application to the registration server, and
the shortcut enables the at least one application to use the web data immediately using the web address of the web data, and
the shortcut is generated by the at least one application.

5. The application search method of claim 4, further comprising the terminal transmitting the shortcut, generated by the application for searching for the web data, to the search client when the web data is retrieved.

6. The application search method of claim 5, further comprising the terminal enabling the at least one application to use the web data immediately through the transmitted shortcut if the search client corresponds to the terminal.

7. The application search method of claim 1, wherein the terminal transmitting an identifier for the application and a web address of web data, used by the application, to the registration server comprises transmitting information on data used by the application, from among data included in the application, to the registration server.

8. The application search method of claim 1, wherein the registration server associating the identifier for the application with the web address of the web data comprises updating a count based on a number of times that the application has accessed the web data if there is a link between the identifier and the web address.

9. An application search method executed in an application search system comprising a web server for storing one or more web data, a registration server, and an application search server, wherein the one or more web data are distinguished from one another by web addresses, at least first part of the one or more web data includes an application identifier indicative of information on an application for searching for the one or more web data in a metadata form, and the at least first part is executed by a terminal, and
the application search method comprising:
the registration server searching the web server for at least second part of the one or more web data;
the registration server associating the application identifier, included in the retrieved web data in the metadata form, with a web address of the retrieved web data; and
the application search server transmitting both information on the web data and the identifier for the application for searching for the web data to a search client when the web data is retrieved.

10. The application search method of claim 9, wherein the search client comprises the terminal.

11. The application search method of claim 9, wherein the application search server transmitting both information on the web data and the identifier for the application for searching for the web data to a search client when the web data is retrieved comprises the application search server accessing the registration server and obtaining the identifier for the application for searching for the web data.

12. The application search method of claim 9, wherein:
the at least first part of the one or more web data further stores a shortcut usable in the at least one application in the metadata form,
the shortcut enables the at least one application to use the web data immediately using the web address of the web data, and
the shortcut is generated by the at least one application.

13. The application search method of claim 12, further comprising the application search server transmitting the shortcut, generated by the at least one application for searching for the web data, to the search client when the web data is retrieved.

14. The application search method of claim 13, further comprising the terminal enabling the at least one application to use the web data immediately through the transmitted shortcut if the search client corresponds to the terminal.

15. An application search method executed in an application search system comprising a terminal for executing an application, a proxy server, a registration server, and an application search server, the application search method comprising:
the terminal transmitting an identifier for the application and a web address of web data, used by the application, to the proxy server;
the proxy server transmitting web data, retrieved based on the web address, to the terminal;
the proxy server transmitting the identifier for the application and the web address of the web data used by the application to the registration server;
the registration server associating the identifier for the application with the web address of the web data; and
the application search server transmitting both information on the web data and the identifier for the application for searching for the web data to a search client when the web data is retrieved.

16. The application search method of claim 15, wherein:
the terminal transmitting an identifier for the application and a web address of web data, used by the application, to the proxy server comprises transmitting a shortcut usable in the at least one application to the proxy server,
the shortcut enables the at least one application to use the web data immediately using the web address of the web data, and
the shortcut is generated by the at least one application.

17. An application search system comprising a terminal for executing an application and a registration server, the application search system comprising:
the terminal configured to transmit an identifier for the application and a web address of web data, used by the application, to the registration server;
a registration server configured to associate the identifier for the application with the web address of the web data; and
an application search server configured to transmit both information on the web data and the identifier for the application for searching for the web data to a search client when the web data is retrieved.

18. The application search system of claim 17, wherein:
the terminal further transmits a shortcut useable in the at least one application to the registration server,
the shortcut enables the at least one application to use the web data immediately using the web address of the web data, and
the shortcut is generated by the at least one application.

19. The application search system of claim 18, wherein the application search server further transmits the shortcut, generated by the application for searching for the web data, to the search client when the web data is retrieved.

20. An application search system comprising a web server for storing one or more web data, a registration server, and an application search server,
wherein the one or more web data are distinguished from one another by web addresses, at least first part of the one or more web data includes an application identifier indicative of information on an application for searching for the one or more web data in a metadata form, and the at least first part is executed by a terminal;
the registration server searches the web server for at least second part of the one or more web data and associates the application identifier, included in the retrieved web data in the metadata form, with a web address of the retrieved web data; and
the application search server transmits both information on the web data and the identifier for the application for searching for the web data to a search client when the web data is retrieved.

21. The application search system of claim 20, wherein:
the at least first part of the one or more web data further includes a shortcut useable in the at least one application in the metadata form,
the shortcut enables the at least one application to use the web data immediately using the web address of the web data, and
the shortcut is generated by the at least one application.

22. The application search system of claim 20, wherein the application search server further transmits the shortcut, generated by the application for searching for the web data, to the search client when the web data is retrieved.
